(19) United States
(12) Patent Application Publication
(10) Pub. No.: US 2009/0187774 A1
(43) Pub. Date: Jul. 23, 2009

(54) Information Recording and Reproducing Apparatus

(76) Inventors: Kouji MINABE, Hitachioota (JP); Hiroaki Tachibana, Hitachinaka (JP); Morio Aoki, Hitachinaka (JP); Kazunori Uemura, Ebina (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/354,807

(22) Filed: Jan. 16, 2009

(30) Foreign Application Priority Data
Jan. 18, 2008 (JP) 2008-008651

(51) Int. Cl. G06F 3/00; G06F 1/26

(52) U.S. Cl. 713/300; 710/36

(57) ABSTRACT

An information recording and reproducing apparatus is disclosed, wherein a hard disk drive or a flash memory in a video camera is accessed by a personal computer having a control program for the recording and reproducing process, through a USB-I/F circuit kept on. A CPU in the video camera, on the other hand, is connected to an external dubbing optical disk having a control program for the recording and reproducing process, through a SATA-I/F circuit only in the case where a user command is given through a switch or power is supplied from an AC adaptor. As a result, the connection with the personal computer is established at an arbitrary timing, and the I/F circuit of the external optical disk can save the power consumption.

### INCORPORATION BY REFERENCE

The present application claims priority from Japanese application JP 2008-008651 filed on Jan. 18, 2008, the content of which is hereby incorporated by reference into this application.

### BACKGROUND OF THE INVENTION

This invention relates to an information recording and reproducing apparatus (an apparatus for recording and/or reproducing the information) such as an information recording apparatus for recording the information in a recording medium, or in particular to the connection of an external device for the dubbing operation of a digital video camera.

The background art in this technical field includes JP-T-2006-508413 (the term “JP-T” as used herein means a published Japanese translation of a PCT application), JP-A-2006-059033, JP-A-2006-059088 and JP-A-2003-339005.

JP-T-2006-508413 contains the description to the effect that “a composite ATA and SATA controller is provided. This controller includes control units (300 to 330) for controlling the data transfer with ATA parallel memory devices (135, 140) and control units (335, 340) for controlling the data transfer with SATA serial memory devices (220, 225). This controller can execute the data transfer with the parallel memory device and the serial memory device at the same time. A composite controller high in cost effectiveness can be realized by reuse of a considerable proportion of the hardware of the controller” (see the “abstract”).

JP-A-2006-059033 contains the description to the effect that “[Subject] To provide a data transfer control system, an electronic device and a program capable of realizing the power supply control operation with a high power saving effect. [Solving Means] A data transfer control system 10 for controlling the data transfer between a PC 1 (first electronic device) connected through a BUS 1 and a HDD 100 (device) connected through a BUS 2, including a connection control unit 52 for giving an attach command to the BUS 1 before switching on the power supply to the HDD 100, a bus status monitor unit 60 for detecting whether the BUS 1 is reset or not after attachment, and a power control unit 90 for controlling the power supply by switching on the power supply to the HDD 100 upon detection of the reset state of the BUS 1” (see the “abstract”).

JP-A-2006-059088 contains the description to the effect that “[Subject] To provide a data transfer control system, an electronic device and a program capable of realizing the power supply control operation with a high power saving effect. [Solving Means] A data transfer control system 10 for controlling the data transfer between a PC 1 (first electronic device) connected through a BUS 1 and a HDD 100 (device) connected through a BUS 2, including a management unit 60 for executing the process of receiving a log-in request which may arrive to acquire the access right to the HDD 100 and executing the process of receiving a log-out request which may arrive from the PC 1 to waive the access right acquired in accordance with the log-in request, and a power supply control unit 90 for controlling the power by switching on the power supply to the HDD 100 with the arrival of the log-in request from the PC1 to the HDD 100” (see the “abstract”).

JP-A-2003-339005 contains the description to the effect that “[Subject] To improve the efficiency of data transfer from an imaging device to an external device. [Solving Means] A video camera 101 includes an IEEE1394 interface 209 for connection to an external device such as a DVD-R deck 102 and has at least two types of data transfer rates. The video camera 101 proceeds to read the address information of the DVD-R deck 102 and acquires the data transfer rate of the DVD-R deck 102 while at the same time storing the particular data transfer rate information in a memory 213. Next, the video camera 101, by accessing the data transfer rate information of the DVD-R deck 102 stored in the memory 213, determines a predetermined data transfer rate from the data transfer rate of the video camera 101 itself, e.g. the maximum data transfer rate coincident between the data transfer rates of the two devices.” (see the “abstract”)

### SUMMARY OF THE INVENTION

The object of this invention is to provide an information recording and reproducing apparatus for solving or improving all or at least a part of the problems of the prior art described above, or for example, to improve the convenience of the user and the battery drive operation time in the information recording and reproducing apparatus.

In order to achieve the object described above, according to this invention, there is provided an information recording and reproducing apparatus having the configuration described in the appended claims. For the purpose of making sure that the PC operates as a bus master for controlling the serial communication line and an external optical disk drive (hereinafter referred to as “ODD”) for dubbing operates not as a bus master on the one hand, and obviating the ambiguity as to whether the serial communication interface means on the video camera operates as a bus master or not on the other hand, for example, the aforementioned problem is solved by the two means described below.

The first means includes at least two serial communication interface means, one of which is a first serial communication interface means operating not as a bus master corresponding to the control operation from the PC, and the other is a second serial communication interface means operating as a bus master for an external ODD.

Further, the first serial communication interface means tolerates the serial communication protocol for other than the hard disk drive (hereinafter referred to as “HDD”) of the video camera, and the second serial communication interface means is based on ATA (Advanced Technology Attachment) for controlling a dubbing ODD.

Furthermore, the second serial communication interface means is dedicated to the dubbing operation, and therefore, includes a means for receiving an express user command to connect the dubbing ODD or a means for detecting the power supply from the AC adaptor without being conscious of power saving thereby to control the power supply to the second serial communication interface means.

The second means includes a single serial communication interface means and a means for selecting an object expressly indicated by the user to be connected with the serial communication interface means thereby to select an external device to be connected with the serial communication interface means. In the case where the external device is a dubbing ODD, the second means includes a means for receiving an express user command to connect the dubbing ODD, or a means for detecting the power supply from the AC adaptor without the need of being conscious of power saving thereby to control the power supply to the serial communication interface means.

In both the first and second means described above, the connectability is expressly indicated by displaying the status of the serial communication interface means on the liquid crystal monitor.

According to this invention, the ambiguity as to whether the serial communication interface means on the information recording and reproducing apparatus operates as a bus master or not is suppressed, while at the same time making it possible to connect an external multipurpose dubbing ODD for an improved convenience of the user. Also, the unnecessary power consumption by the serial communication interface means can be suppressed, thereby improving the operation time of the information recording and reproducing apparatus driven by the battery.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram for explaining the configuration of a first embodiment of the invention.

FIG. 2 is a block diagram for explaining a first example of the configuration of the information recording and reproducing apparatus connected to an external device.

FIG. 3 is a block diagram for explaining a second example of the configuration of the information recording and reproducing apparatus connected to an external device.

FIG. 4 is a block diagram for explaining a third example of the configuration of the information recording and reproducing apparatus connected to an external device.

FIG. 5 is a block diagram for explaining a fourth example of the configuration of the information recording and reproducing apparatus connected to an external device.

FIG. 6 is a block diagram for explaining the configuration of a second embodiment of the invention.

### DETAILED DESCRIPTION OF THE INVENTION

Prior to the explanation of embodiments of the invention, the interface for connecting the information recording and reproducing apparatus and an external device to each other is explained.

A parallel interface based on ATA is used as an interface means to each of a HDD and an ODD.

These interfaces, though having many connecting wires and capable of transmission at low frequency as compared with the serial interface described later, are advantageous in terms of power consumption, and therefore, used for HDD or ODD connection in electronic devices.

In view of the configuration in which electronic devices are connected to each other to perform the recording and reproducing operation from one electronic device to the HDD or ODD of the other or in which an external HDD or ODD is connected to an electronic device, on the other hand, the transmission techniques using the SATA (Serial Advanced Technology Attachment) interface, USB (Universal Serial Bus) interface and the IEEE1394 interface are available which can be realized by the serial connection permitting the ATA transmission with a compact connector having a smaller number of connecting wires.

These interfaces are realized by the configuration which has an appropriate buffer memory as required and in which the control operation to convert the parallel ATA signal into a serial signal is performed in two ways between the transmitter and the receiver. Especially, SATA realizes the serial communication with a device controlled in accordance with the control protocol based on ATA.

According to USB and IEEE1394, on the other hand, the connection and the communication protocol of all the devices in serial connection are set as a lower rank. Specifically, the connection of a device controlled by the ATA control protocol according to USB or IEEE1394 is an example of the application using USB or IEEE1394, respectively. Therefore, other devices than the ATA devices can be arranged over the connection of USB and IEEE1394.

Further, IEEE1394 contains no command for the control procedure of recording and reproduction of a device such as HDD, ODD or magnetic tape. Thus, IEEE1394 is used also for transfer, as an appropriate bit stream based on the transfer format protocol, of the video or audio information reproduced from or to be recorded in these devices.

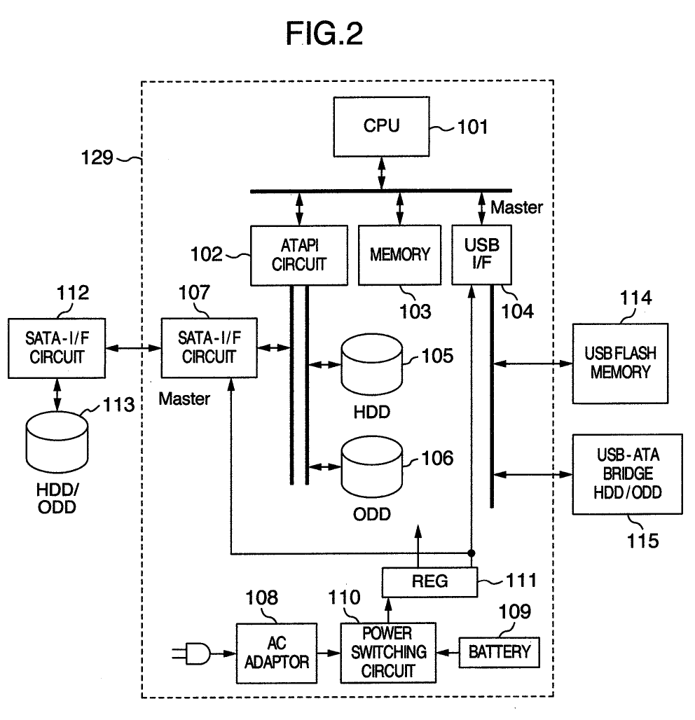

A specific example of the apparatus having the connection in a serial communication path with an external device as described above is explained with reference to FIGS. 2 to 5.

FIG. 2 shows a specific example of the personal computer (PC) having a serial communication. A memory 103 is used as an operation memory of the operating system or the application program operated on the PC on the one hand and as a buffer memory for recording/reproduction to and from each device on the other hand.

In the case where the various applications processed in the CPU 101 are recorded in a HDD 105 or an ODD 106 through the operating system, the information to be written and the place where it is written in the HDD 105 or the ODD 106, as the case may be, are set through an ATAPI (Advanced Technology Attachment Packet Interface) circuit 102. In the case of reproduction, on the other hand, the place where the information to be reproduced is stored is designated through the ATAPI circuit 102.

The place where the information is to be written and the place where the information to be reproduced is stored are recorded in a specified place on the HDD 105 or the ODD 106 as file management information (file management data) by the operating system. Before reproduction, therefore, the file management information is read and whereabouts of the desired information is grasped, while the data is written to update the file management information at the time of recording.

As described above, the actual recording and reproduction operation of the information recording and reproducing apparatus requires the operation of the CPU 101 to control the recording and reproducing procedure.

This is also the case with other connected devices. As to an external HDD/ODD 113, the CPU 101 executes the process on the ATAPI circuit 102 similar to the aforementioned process. Then, the particular information is transmitted through SATA-I/F circuits 107, 112 while at the same time being controlled to perform the desired recording/reproduction control operation.

A similar process is executed also for recording into or reproducing from the flash memory 114. Based on the file management information stored in a specified area on the flash memory 114, the desired place of recording/reproduction is specified. Then, the recording/reproduction process is executed and the recording/reproduction information transmitted/received through the USB-I/F circuit 104 by the CPU 101. The HDD/ODD 115 is also similarly controlled through the USB.

An external device is not always connected. The SATA-I/F circuit 107 and the USB-I/F circuit 104, therefore, are constantly supplied with power from a power supply stabilized at the desired voltage by a regular circuit 111 based on the power supplied from an AC adaptor 108 or a battery 109a through a power switching circuit 110.

Even in the case where an external device is connected to the serial communication path for the convenience of the user, therefore, the circuit stands by in the state ready to recognize the connection.

As described above, in the case of the PC, the CPU 101 becomes a bus master for recognition of the recording/reproduction process of the connected external device and the connection of the connected external device.

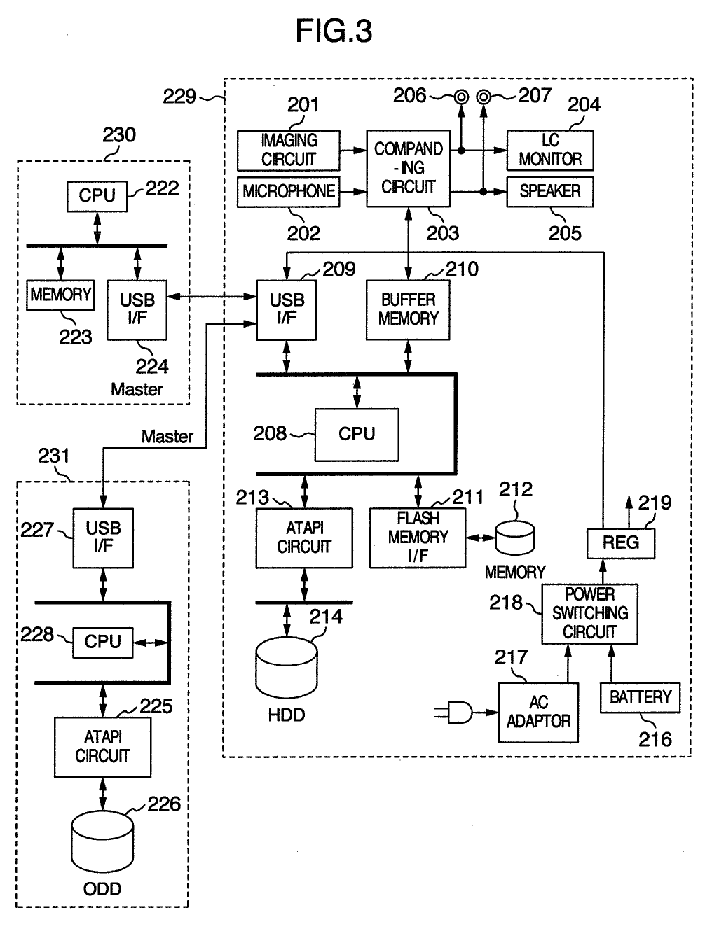

Next, a specific example of a case in which the video camera has a serial communication is explained with reference to FIG. 3. The video camera 229 is connected with a personal computer 230 and a dubbing ODD 231 as external devices.

The video signal picked up by an imaging circuit 201 and the audio signal collected by a microphone 202 are compressed by a compression and extension coder/decoder circuit (hereinafter called a companding circuit) 203 to reduce the redundant information amount of the signal, and stored as the record information in the buffer memory 210. The CPU 208 grasps the place where the record information is stored in the buffer memory 210 on the one hand and, by a similar method to the aforementioned case of the PC, grasps the place where the information is recorded in the HDD 214.

These two types of information are designated through the ATAPI circuit 213, so that the audio-visual information is recorded in the HDD 214. Once the audio-visual information is completely recorded, the recording operation to update the file management information as to the place where the particular information is stored in the HDD 214 is performed on the HDD 214 through the ATAPI circuit 213.

Before the audio-visual information is reproduced, the file management information is read from the HDD 214 through the ATAPI circuit 213 to grasp the place where the audio-visual information to be reproduced is stored. This storage information and the place where the reproduced information is developed and stored in the buffer memory 210 are designated to the ATAPI circuit 213 and reproduced from the HDD 214. The audio-visual information developed in the buffer memory 210 is decompressed by the companding circuit 203 and output as video information and audio information through the liquid crystal monitor circuit 204 and the speaker 205, respectively.

In a similar manner, the audio-visual information can be recorded in and reproduced from a memory 212 through a flash memory I/F 221. The only difference is that the command system for issuing a command to execute the write/read steps is different from the ATA command system. The place of storage is specified based on the file management information and the the write/read operation performed sequentially using the buffer memory in the same way as described above.

The PC 230 reads the audio-visual information recorded in the HDD 214 or modifies and writes back the modified audio-visual information to the HDD 214.

The CPU 222 recognizes the connection of the USB-I/F 209 to the USB-I/F 224. The USB-I/F 209 is supplied with the power stabilized at the desired voltage by the regular circuit 219, based on the power generated in the AC adaptor 217 or the battery 216 and selectively supplied through the power switching circuit 218, thereby entering the standby state ready for connection to the PC 230 at an arbitrary timing.

Upon complete recognition of the connection, the CPU 222 gives a command through the USB-I/F 209 to read the file management information from the HDD 214. In response to this command, the CPU 208 in the video camera reads the file management information from the HDD 214 through the ATAPI circuit 213 and develops it in the buffer memory 210. The CPU 208 designates to the USB-I/F 209 where to store the developed file management information on the buffer memory 210, while at the same time giving a command for distribution to the USB bus. As a result, the CPU 222 receives the file management information through the USB-I/F 224 and develops it in the working area in the memory 223.

Based on this file management information, the CPU 222 specifies the place in the HDD 214 to store the audio-visual information and again issues a command designating the storage place of the desired audio-visual information through the USB-I/F 224. The response of the CPU 8 on the part of the video camera to this command is similar to that of the file management information.

In the case where the audio-visual information modified is written back to the HDD 214 in the video camera from the PC 230, the place in the HDD 214 where the information written back is to be stored and the desired audio-visual information to be stored are transmitted to the CPU 222 through the USB-I/F 224. The USB-I/F 209 on the video camera side notifies the CPU 208 of the place where the audio-visual information is stored in the HDD 214, while at the same time developing the audio-visual information to be recorded, in the buffer memory 210.

In response, the CPU 208 issues a command to the ATAPI circuit 213 designating the places where the audio-visual information are to be recorded and stored in the buffer memory 210 and the HDD 214, and records the information in the HDD 214. Next, the CPU 222 updates the file management information in the HDD 214 through the steps similar to those for recording the audio-visual information.

As described above, in the case where the PC 230 reads or writes back the audio-visual information, the recognition of the device connection and the recording and reproduction steps are carried out by the PC 230 operating as a bus master.

Also in the case where the dubbing ODD 231 is connected, the CPU 228, like the CPU 222, operates as a bus mater so that the desired audio-visual information on the HDD 214 to be dubbed is read to the ODD 226 through USB-I/F 227, 209 and developed in a buffer memory (not shown) under the control of the CPU 228. The CPU 228 dubs by writing the particular information in the ODD 226 through the ATAPI circuit 225.

As described above, also in the case where the ODD 231 reads the audio-visual information for dubbing, the ODD 231 performs the control operation as a bus master for recognition of the device connection and the recording and reproducing process. Also, according to this embodiment, each of the PC 230 and the dubbing ODD 231 is exclusively connected to the USB-I/F 209 of the video camera 229.

According to this embodiment, the CPU 208 is interposed between the USB-I/F 209, the buffer memory 210 and the ATAPI circuit 213 to read from or write into the HDD 214. This is by reason of the fact that the non-ATA recording and reproducing devices such as the flash memory I/F 211 and the flash memory 212 are arranged under the control of the CPU 208, and the buffer memory 210 is used to access and write into the PC 230 and the dubbing ODD 231 thereof.

In the case where only an ATA device is arranged under the control of a given USB line as a method of controlling the ATA device using the USB, a mechanism (USB-ATA bridge circuit) may be employed in which the USB serial signal and the ATA parallel signal are converted to each other without any program from the CPU using the USB-I/F 209 and the buffer memory 210.

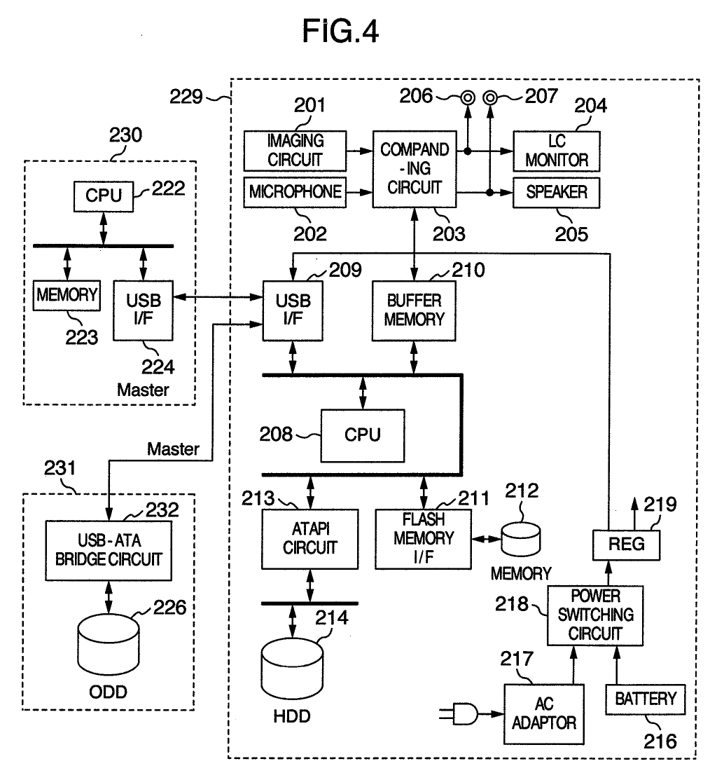

In that case, as shown in FIG. 4, the dubbing ODD 231 can be simplified. Specifically, the ODD 226 is controlled directly through the USB-ATA bridge circuit 232. In this case, the USB-I/F 209 and the CPU 208 each operate as a bus master for the process of reading the audio-visual information recorded in the HDD 214 for dubbing, writing into the ODD 226 and the recognition of connection of the dubbing ODD 231.

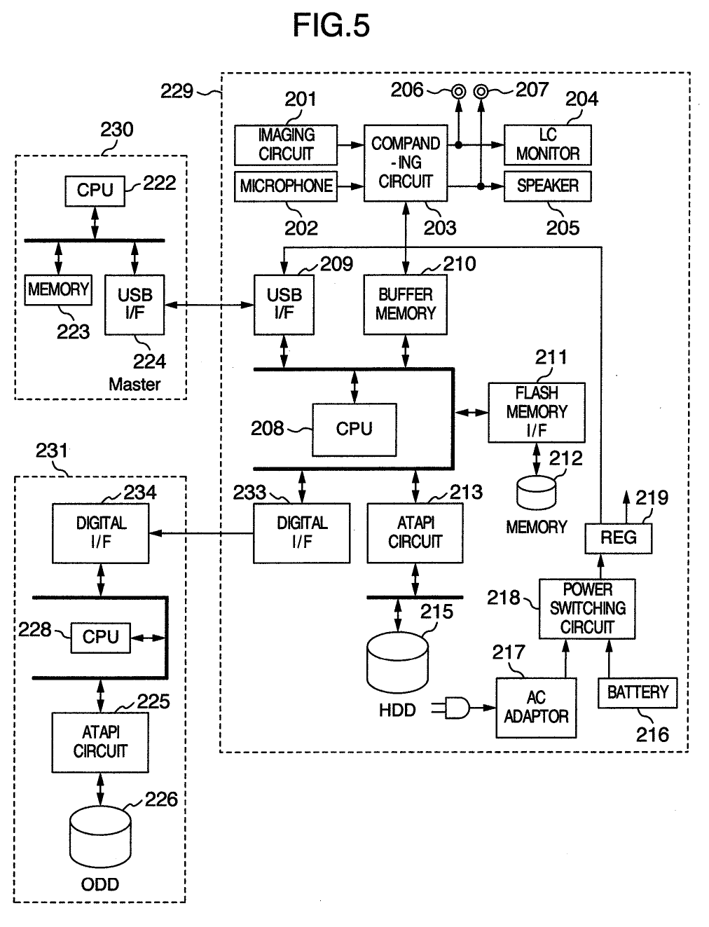

Also, as shown in FIG. 5, the dubbing operation may be carried out by connecting the video camera 229 and the dubbing ODD 231 without the recording and reproducing process. According to this method, the transmission signal of the audio-visual information is transmitted always based on a predetermined transmission format and transmission rate (the transmission rate may be in multiple stages). In this case, the read operation from the HDD 214 and the transmission control operation are performed by the CPU 208, while the receiving operation and the write control operation into the ODD 226 are carried out by the CPU 228. This type of connection also exists as a method of combining the video camera and the digital recorder.

The technique described above, however, fails to take the following fact into consideration.

In the case of FIG. 3, for example, the process of reading the audio-visual information from within the HDD of the video camera and the recording process for writing into the ODD are required to be executed by the dubbing ODD. Therefore, the user is required to purchase the ODD having a special function as an option.

Also, the dubbing ODD operates as a bus master for connection recognition. Therefore, the video camera is required to be connected only after the dubbing ODD switched on completes at least the initialization of the USB-I/F and becomes ready for operation.

Further, in order to connect the video camera and the PC at an arbitrary timing, the USB-I/F of the video camera is required to be kept on. Even in the application to enjoy only the imaging operation, therefore, the power is consumed for USB-I/F undesirably. An alternative method to suppress the USB-I/F power consumption is available in which power is supplied only for a predetermined duration after the video camera is switched on and the initialization of the USB-I/F is finished, and subsequently, upon complete recognition of the connection, power continues to be supplied while in the case where the connection fails to be recognized, on the other hand, power supply to the USB-I/F is stopped (the disconnection circuit not shown). This method poses the problem, however, that the connectability with the PC at an arbitrary timing is lost.

Although the special characteristic of the dubbing ODD is not shown in FIG. 4, whether the USB-I/F circuit of the video camera operates as a bus master or a bus slave is varied with the device connected and unknown before the device is actually connected. Therefore, the problem is posed that the CPU 208 is difficult to control against the USB-I/F circuit 209.

Further, in the case of FIG. 5, like in FIG. 3, the CPU 228 of the dubbing ODD is required to have the sophisticated added functions including the function of controlling the recording operation into the ODD and the function of interpreting the transmission format of the digital I/F.

Embodiments of the invention are explained below.

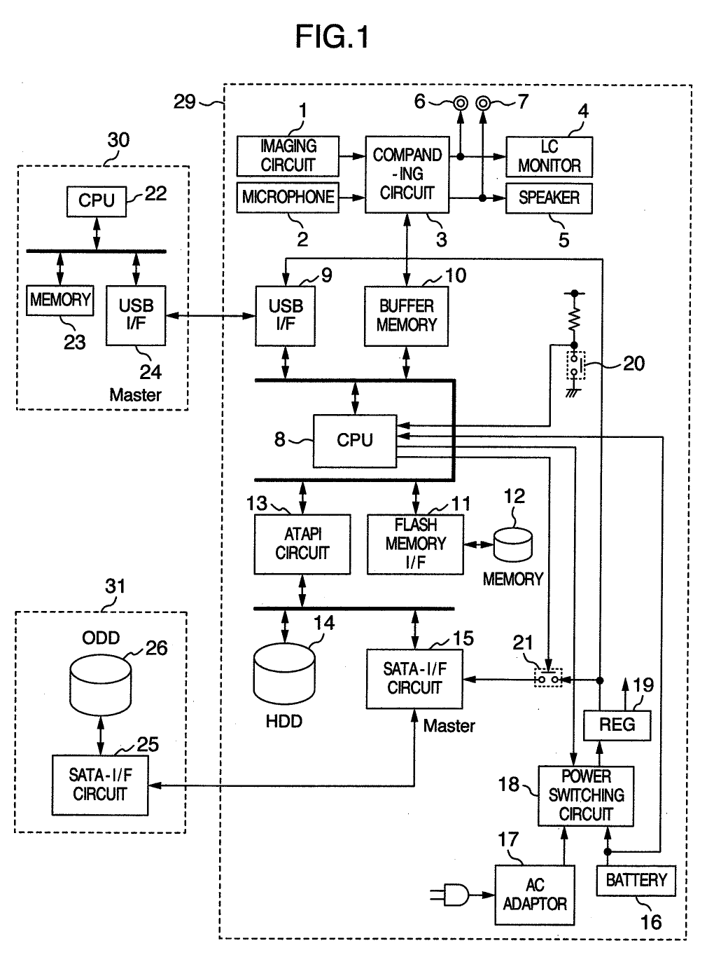

A first embodiment of the invention is shown in FIG. 1.

First, the configuration of the first embodiment is explained. Reference numeral 29 designates a video camera proper as an example of the recording and reproducing apparatus according to the invention. Numeral 30 designates a personal computer (PC), and numeral 31 an external dubbing ODD. Each of these devices is described as an example of the external devices connected to the video camera 29 to explain the embodiments of the invention.

Next, the configuration of the video camera 29 is explained. First, the configuration of the camera and the display function are described.

Numeral 1 designates an imaging circuit for picking up an image as an electrical signal. Numeral 2 designates a microphone for converting the sound into an electrical signal. Numeral 3 designates a companding circuit including a compression circuit for generating the audio-visual signal with the information amount compressed by removing the redundancy thereof and a decompression circuit for reproducing the video and audio signals from the compressed audio-visual information. Numeral 4 designates a liquid crystal monitor circuit for displaying the video signal, and numeral 5 a speaker for converting the audio signal into the sound wave. Also, numerals 6 and 7 designate output terminals for displaying the video and audio signals by connecting them to the TV.

Next, the configuration of the interface of the video camera 29 with external devices and the recording and reproducing block thereof is explained. Numeral 9 designates a USB-I/F circuit used for connection with the PC 30, numeral 10 a buffer memory for exchanging information with various interfaces and the companding circuit 3, numeral 11 an interface circuit with the flash memory 12, numeral 13 an interface circuit (ATAPI circuit) for connection with the HDD 14, and numeral 15 a SATA-I/F circuit for connection with the external dubbing ODD 31. Numeral 8 designates a CPU for controlling these circuits.

Next, the configuration of the power block and the operation block of the video camera 29 is explained. Numeral 16 designates a battery, numeral 17 an AC adaptor for generating the DC voltage from the commercial power supply, and numeral 18 a power switching circuit for selectively supplying the DC voltage of the battery 16 or the AC adaptor 17 to a stabilized power supply circuit. Numeral 19 designates a regulator circuit for generating the DC voltage of various values used for the various points in the video camera, numeral 20 an operation switch operated by the user to expressly indicate the connection of the dubbing ODD 31, and numeral 21 a switching circuit for disconnecting the power to the SATA-I/F circuit 15.

Next, the configuration of the PC 30 is explained. Numeral 22 designates a CPU, numeral 23 a buffer memory for arranging the processing program or storing the data, and numeral 24 a USB-I/F circuit for connecting to the video camera 29.

Next, the configuration of the external dubbing ODD is explained. Numeral 25 designates a SATA-I/F circuit, and numeral 26 an ODD operated according to the ATA control protocol.

Now, the operation of this embodiment is explained.

The video signal picked up by the imaging circuit 1 and the audio signal collected by the microphone 2 are compressed by the companding circuit 3 for reducing the redundant information amount of the signal and stored as recording information in the buffer memory 10. Also, the CPU 8 grasps the recording information in the buffer memory 10. The CPU 8 further reads, from the HDD 14, the file management information indicating the place where the information is to be written and the manner in which the information is stored in the HDD 14. The file management information is stored in a specified place or a place that can be searched through specified steps in the HDD 14, and the storage place of the file management information is set by the ATAPI circuit 13, which is instructed to reproduce the file management information. Accordingly, the file management information in the HDD 214 is reproduced and developed in the buffer memory 10 through the ATAPI circuit 13.

The CPU 8 finds a vacant area of the HDD 14 from the file management information. This vacant area and the area to store the audio-visual information on the buffer memory 10 are set in the ATAPI circuit 13. Then, an instruction is given to record the information in the HDD 14, and the recording operation is performed.

Also, upon complete recording operation of the audio-visual information, the file management information indicating where the information is stored in the HDD 14 is updated. The file management information thus updated is recorded in the HDD 14 according to similar steps to the recording operation of the audio-visual information.

Before reproducing the audio-visual information, on the other hand, the file management information is read from the HDD 14 through the ATAPI circuit 13 to grasp the storage place of the audio-visual information to be reproduced. This storage information and the place where the reproduced information is to be stored and developed in the buffer memory 210 are designated as a command to the ATAPI circuit 13 to reproduce the information from the HDD 14. The audio-visual information developed in the buffer memory 10 is decompressed by the companding circuit 6, and displayed and output as audio and video information through the liquid crystal monitor circuit 4 and the speaker 5, respectively.

The audio-visual information can also be recorded into and reproduced from the memory 12 through the flash memory I/F circuit 11. The only difference from the ATA command is the command system for issuing a command designating the write/read steps. The concept of specifying the storage place based on the file management information and writing and reading the information sequentially using the buffer memory is the same.

The PC 30 reads the audio-visual information recorded in the HDD 14 or writes back the read and modified audio-visual information into the HDD 14.

The CPU 22 recognizes the connection of the USB-I/F circuit 9 to the USB-I/F circuit 24. The USB-I/F circuit 9, based on the power generated by the AC adaptor 17 or the battery 16 and selectively supplied through the power switching circuit 18, is supplied with the power stabilized at the desired voltage by the regulator circuit 19. In this way, the CPU 22 enters the standby mode ready for connection with the PC 30 at an arbitrary timing.

Upon complete recognition of the connection, the CPU 22 gives a command through the USB-I/F circuit 9 to read the file management information from the HDD 14. In response to this command, the CPU 8 in the video camera reads the file management information from the HDD 14 through the ATAPI circuit 13 and develops it in the buffer memory 10. The CPU 8 gives a command to the USB-I/F circuit 9 designating the place where the developed file management information is stored in the buffer memory 10 and to distribute it to the USB bus. As a result, the CPU 22 receives the file management information through the USB-I/F circuit 24 and develops it in the working area in the memory 23.

The CPU 22, based on the file management information, specifies the place where the audio-visual information is stored in the HDD 14, and gives a command designating again, through the USB-I/F circuit 24, the place where the desired audio-visual information is to be stored. The response of the CPU 8 of the video camera to this command is similar to that for the file management information.

In the case where the audio-visual information thus modified is written back to the HDD 14 in the video camera from the PC 30, the place where the written-back information is stored in the HDD 14 and the desired audio-visual information to be stored are transmitted to the CPU 22 through the USB-I/F circuit 24. The USB-I/F circuit 9 of the video camera notifies the CPU 8 of the place where the information is stored in the HDD 1, while at the same time developing the recorded audio-visual information in the buffer memory 10.

In response, the CPU 8 gives a command to the ATAPI circuit 13 designating the place where the audio-visual information is to be recorded in the HDD 14 from the buffer memory 10 thereby to carry out the record operation into the HDD 14. Next, the CPU 22 updates the file management information in the HDD 14 through the steps of the process similar to those for recording the audio-visual information.

As described above, in the case where the PC 30 reads or writes back the audio-visual information, the recognition of device connection and the steps of recording and reproducing the audio-visual information are carried out by the PC 30 as a bus master. On the other hand, the dubbing ODD 31 is connected to the SATA-I/F circuit 15 of the video camera 29, and the operation is performed for recognition by the video camera 29 as follows:

First, the video camera 29 activates the AC adaptor 17. In the case where the battery is driven in the process, the CPU 8 monitors the voltage to detect the voltage drop due to the battery consumption. At the time of driving the video camera 29 with the battery, therefore, the voltage signal makes it possible to recognize that the apparatus is driven by the battery. In the case where the apparatus is driven by the AC adaptor 17, on the other hand, the drive with the AC adaptor can be detected from the fact that the aforementioned signal detection is lacking.

In the case of driving with the AC adaptor, the video camera 29 is not required to be regarded as an important means of power consumption as a mobile device. Therefore, the CPU 8 closes the power conduction control switch 21 to keep supply power to the SATA-I/F circuit 15. As an alternative, the SATA-I/F circuit 15 is kept on in the case where the user expressly sets the external dubbing ODD in connection by operating the switch 20.

Once the aforementioned conditions are met, the external ODD is switched on. Then, the communication is established between the SATA-I/F circuit 25 and the SATA-I/F circuit 15.

Next, the CPU 8 operates as a bus master as follows in the case where the audio-visual information in the HDD 14 is dubbed to the dubbing ODD 31.

In order to grasp the place where the desired audio-visual information to be dubbed is stored, the CPU 8 first reads the file management information recorded in the HDD 14. The steps of the reading process are similar to those described above. From the file management information thus read, the place where the audio-visual information to be dubbed is stored is specified, and the information is read and developed in the buffer memory 10 in the same manner as described above.

Then, the CPU 8 reads the file management information from the ODD 26 through the ATAPI circuit 13, the SATA-I/F circuit 15 and the SATA-I/F circuit 25. From this file management information, a vacant area of the ODD 26 is found, so that the place of storing the dubbing audio-visual information already developed in the buffer memory 10 and the vacant area of the ODD 26 are set in the ATAPI circuit 13 thereby to perform the record operation. Once the audio-visual information is completely recorded in the ODD 26, the ATAPI circuit 13 is set for updating the file management information of the ODD 26 in a similar manner thereby to perform the write operation for updating the file management information.

As described above, the recognition of connection in the dubbing operation to the dubbing ODD 31 and the control operation of the recording and reproducing process are carried out by the video camera 29 as a bus master.

According to this embodiment, as compared with the prior art, the serial communication interface is multiplexed without increasing the standby power consumption of the interface circuit. As a result, the external drive can be provided at low cost without any drive unit otherwise required as a bus master to control the recording and reproducing steps as an external dubbing ODD.

Also, the external drive is recognized by the video camera. Therefore, the inconvenience of the failure to recognize the connection at an appropriate timing before complete initialization of the USB-I/F circuit after switching on the external drive is avoided.

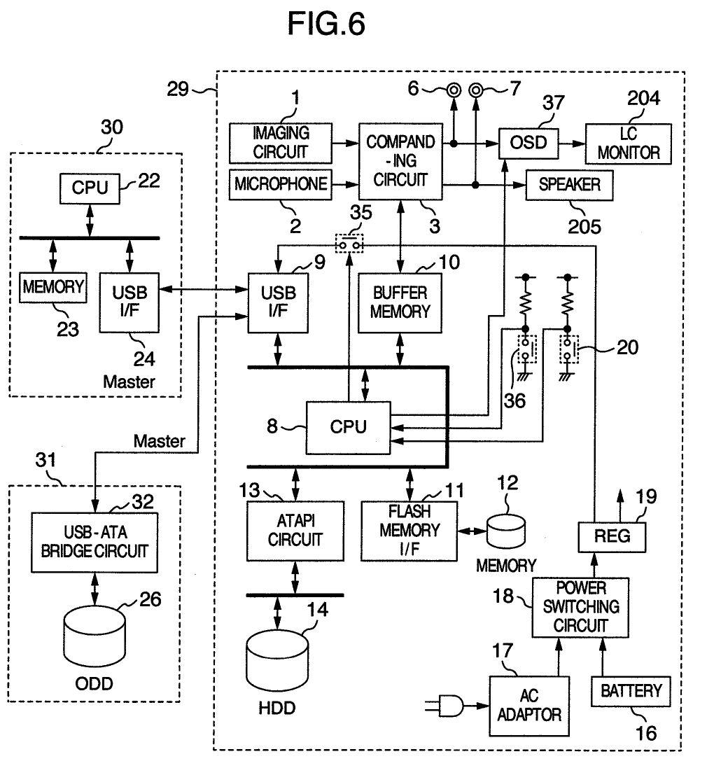

Next, the second embodiment of the invention is explained with reference to FIG. 6. The configuration and operation of the embodiment shown in FIG. 6 are substantially identical with those of FIG. 1, and therefore, only the difference is explained below.

FIG. 6 shows an example of configuration having a single serial communication interface, to which the component elements described below are newly added. Numeral 32 designates a USB-ATA conversion circuit for converting the USB signal directly into an ATA parallel signal, numeral 35 a power disconnection switch, and numeral 36 a switch for designating whether the USB-I/F circuit 9 is to be used for PC connection or as an I/F circuit of the external dubbing ODD. Numeral 37 designates an OSD (on-screen display) circuit.

Next, the operation units different from those in FIG. 1 are explained. First, before connection with the PC, the CPU 8 is instructed through the switch 36 to use the USB-I/F circuit 9 for the purpose of PC connection. As a result, the power switch 35 for the USB-I/F circuit 9 is kept on under the control of the CPU 8. Also, the CPU 8 controls by displaying, using a text or characters through the OSD circuit 37, that the state of the USB-I/F circuit is currently set for PC connection.

Assuming that the PC is connected under this condition, the USB-I/F circuit 9 is not required to recognize the connection through the CPU 8. As a result, the conflict of recognition between the USB-I/F circuit 9 and the USB-I/F circuit 24 of the PC as a bus master can be avoided.

In the case where the USB-I/F circuit 9 is set for connection of the external ODD 31 by the switch 36, on the other hand, the energization/deenergization of the USB-I/F circuit 9 is controlled by the CPU 8 according to the setting of the switch 20. Specifically, the USB-I/F circuit 9 is energized only to use the ODD 31. As a result, the unnecessary power consumption by the USB-I/F circuit 9 can be suppressed. Conversely, the connection can be recognized in the case where the external ODD is connected with the switch 35 on.

Next, when dubbing the audio-visual information in the HDD 14 to the ODD 26, the audio-visual information to be dubbed is read by the CPU 8 through the ATAPI circuit 13 and developed in the buffer memory 10. Then, the dubbing is carried out by recording in the ODD 26 through the USB-I/F circuit 9 and the USB-ATA conversion circuit 32.

According to this embodiment, the configuration for connection of an external device of the video camera can be realized without increasing the number of the serial communication interfaces while at the same time minimizing the power of the serial communication interface circuit out of operation.

It should be further understood by those skilled in the art that although the foregoing description has been made on embodiments of the invention, the invention is not limited thereto and various changes and modifications may be made without departing from the spirit of the invention and the scope of the appended claims.

1. An information recording and reproducing apparatus comprising:
means for recording and reproducing the information;
first interface means through which a first external device transmits and receives the recording and reproducing information to and from the recording and reproducing means along a first communication path for controlling the communication of a recording and reproducing command given to a device connected on the first communication path and the recording and reproducing information containing the command;
second interface means through which a second external device transmits and receives the recording and reproducing information to and from the recording and reproducing means along a second communication path; and
communication control means for controlling the recording and reproducing command to the device connected on the second communication path and the recording and reproducing information containing the command;
wherein the source of the command given to the recording and reproducing means to record and reproduce the recording and reproducing information is different between the recording and reproducing operation through the first interface means and the recording and reproducing operation through the second interface means.

2. The information recording and reproducing apparatus according to claim 1,
wherein the first interface means is based on USB (Universal Serial Bus) and the second interface means is based on SATA (Serial Advanced Technology Attachment).

3. The information recording and reproducing apparatus according to claim 1, further comprising:
power disconnecting means for connecting/disconnecting the power supplied to the second interface means;
wherein power is supplied to the second interface means only in the case where the second external device is connected to the second interface means through the second communication path.

4. The information recording and reproducing apparatus according to claim 3, further comprising:
first power supply means derived from a commercial power supply for supplying power to the apparatus;
second power supply means derived from a storage battery power supply; and
power switching control means for controlling the operation of switching between the first power supply means and the second power supply means;
wherein the second external device is connected to the second interface means only in the case where power is supplied by the first power supply means.

5. The information recording and reproducing apparatus according to claim 3, further comprising:
operation command means for giving an express command to connect the second external device to the second interface means;
wherein power is supplied to the second interface means in the case where the user gives a command through the operation command means to connect the second external device.

6. An information recording and reproducing apparatus comprising:
imaging means for converting an object image into the video recording information;
recording and reproducing means for recording and reproducing the video recording information;
first recording and reproduction control means for giving a command to the recording and reproducing means to record and reproduce the video recording information;
first interface means through which a first external device transmits and receives the recording and reproducing information to and from the recording and reproducing means through a first communication path for controlling the communication of a recording and reproducing command given to a device connected on the first communication path and the recording and reproducing information containing the command;
second interface means through which a second external device transmits and receives the recording and reproducing information to and from the recording and reproducing means along a second communication path;
second recording and reproduction control means for giving a recording and reproducing command to the device connected on the second communication path; and
communication control means for supplying the recording and reproducing information containing the recording and reproducing command to the second external device;
wherein the source of the command to the recording and reproducing means to record and reproduce the recording and reproducing information is different between the recording and reproducing operation through the first interface means and the recording and reproducing operation through the second interface means.

7. The information recording and reproducing apparatus according to claim 6,
wherein the first interface means is based on USB (Universal Serial Bus) and the second interface means is based on SATA (Serial Advanced Technology Attachment).

8. The information recording and reproducing apparatus according to claim 6, further comprising:
power disconnecting means for connecting/disconnecting the power supplied to the second interface means;
wherein power is supplied to the second interface means only in the case where the second external device is connected to the second interface means through the second communication path.

9. The information recording and reproducing apparatus according to claim 8, further comprising:
first power supply means derived from a commercial power supply for supplying power to the apparatus;
second power supply means derived from a storage battery power supply; and
power switching control means for switching between the first power supply means and the second power supply means;
wherein the second external device is connected to the second interface means only in the case where power is supplied by the first power supply means.

10. The information recording and reproducing apparatus according to claim 8, further comprising:
operation command means for issuing an express command to connect the second external device to the second interface means;
wherein power is supplied to the second interface means in the case where the user gives a command through the operation command means to connect the second external device.

11. An information recording and reproducing apparatus comprising:
information recording and reproducing means;
first interface means through which a first external device transmits and receives the recording and reproducing information to and from the recording and reproducing means along a first communication path for controlling the communication of the recording and reproducing command given to a device connected on the first communication path and the recording and reproducing information containing the command;
second interface means through which a second external device transmits and receives the recording and reproducing information to and from the recording and reproducing means along a second communication path;
communication control means for giving a recording and reproducing command and the recording and reproducing information containing the command to the device connected on the second communication path; and
power disconnection means for connecting/disconnecting the power supplied to the second interface means;
wherein the source of the command given to the recording and reproducing means to record and reproduce the recording and reproducing information is different between the first interface means and the second interface means; and
wherein power is supplied only in the case where the second external device is connected to the second interface means.

12. The information recording and reproducing apparatus according to claim 11,
wherein the first interface means is based on USB (Universal Serial Bus) and the second interface means is based on SATA (Serial Advanced Technology Attachment).

13. The information recording and reproducing apparatus according to claim 11, further comprising:
power disconnecting means for connecting/disconnecting the power supplied to the second interface means;
wherein power is supplied only in the case where the second external device is connected to the second interface means.

14. The information recording and reproducing apparatus according to claim 13, further comprising:
first power supply means derived from a commercial power supply for supplying power to the apparatus;
second power supply means derived from a storage battery power supply; and
power switching control means for controlling the power switching operation between the first power supply means and the second power supply means;
wherein the second external device is connected to the second interface means only in the case where power is supplied by the first power supply means.

15. The information recording and reproducing apparatus according to claim 13, further comprising:
operation command means for giving an express command to connect the second external device to the second interface means;
wherein power is supplied to the second interface means in the case where the user gives a command through the operation command means to connect the second external device.

16. An information recording and reproducing apparatus comprising:
imaging means for converting an image into the recording information;
recording and reproducing means for recording and reproducing the image recording information;
first recording and reproduction control means for giving a command to the recording and reproducing means to record and reproduce the image recording information;
first interface means through which a first external device transmits and receives the recording and reproducing information to and from the recording and reproducing means along a first communication path for controlling the communication of a recording and reproducing command given to a device connected on the first communication path and the recording and reproducing information containing the command;
second interface means through which a second external device transmits and receives the recording and reproducing information to and from the recording and reproducing means along a second communication path;
second recording and reproduction control means for giving a recording and reproducing command to the device connected on the second communication path;
communication control means for supplying the recording and reproducing information containing the recording and reproducing command to the second external device; and
power disconnection means for connecting/disconnecting the power supplied to the second interface means;
wherein the source of the command given to the recording and reproducing means to record and reproduce the recording and reproducing information is different between the first interface means and the second interface means; and
wherein power is supplied only in the case where the second external device is connected to the second interface means.

17. The information recording and reproducing apparatus according to claim 16,
wherein the first interface means is based on USB (Universal Serial Bus) and the second interface means is based on SATA (Serial Advanced Technology Attachment).

18. The information recording and reproducing apparatus according to claim 16, further comprising:
power disconnecting means for connecting/disconnecting the power supplied to the second interface means;
wherein power is supplied only in the case where the second external device is connected to the second interface means.

19. The information recording and reproducing apparatus according to claim 18, further comprising:
first power supply means derived from a commercial power supply for supplying power to the apparatus;
second power supply means derived from a storage battery power supply; and
power switching control means for controlling the power switching operation between the first power supply means and the second power supply means;
wherein the second external device is connected to the second interface means only in the case where power is supplied by the first power supply means.

20. The information recording and reproducing apparatus according to claim 18, further comprising:
operation command means for giving an express command to connect the second external device to the second interface means;
wherein power is supplied to the second interface means in the case where the user gives a command through the operation command means to connect the second external device.

21. An information recording and reproducing apparatus comprising:
imaging means for converting an image into the recording information;
recording and reproducing means for recording and reproducing the image recording information;
first recording and reproduction control means for giving a command to the recording and reproducing means to record and reproduce the image recording information;
interface means through which a first external device transmits and receives the recording and reproducing information to and from the recording and reproducing means along a communication path for controlling the communication of a recording and reproducing command given to a device connected on the communication path and the recording and reproducing information containing the command;
second recording and reproduction control means for giving a recording and reproducing command to a second external device;
communication control means for controlling the recording and reproducing information containing the recording and reproducing command to the second external device; and
control command means for the user to give a command to determine, using the interface means, whether the source of the recording and reproducing command given to the recording and reproducing means is existent on the external device or in the apparatus;
wherein the recording and reproducing information is transmitted and received between the second external device and the recording and reproducing means through the interface means.

22. The information recording and reproducing apparatus according to claim 21, further comprising:
display means;
wherein in the case where the control command means is so set that the source of the recording and reproducing command to the recording and reproducing means is existent on the external device, the fact is displayed on the display means.

23. The information recording and reproducing apparatus according to claim 21, further comprising:
power conduction disconnection means for disconnecting the power to the interface means; and
second control command means;
wherein in the case where the control command means is so set that the source of the recording and reproducing command to the recording and reproducing means is existent on the external device, power is supplied through the power conduction disconnection means, while in the case where the control command means is so set that the source of the recording and reproducing command to the recording and reproducing means is existent in the apparatus, the second control command means selectively disconnects the power to the interface means through the power conduction disconnection means.
